(19) United States
(12) Patent Application Publication
(10) Pub. No.: US 2015/0019362 A1
(43) Pub. Date: Jan. 15, 2015

(54) SYSTEM AND METHOD FOR CREATING FRACTIONAL OWNERSHIP OF PHYSICAL GOODS

(71) Applicant: Stephanie Yinman Chan, Saratoga, CA (US)

(72) Inventor: Stephanie Yinman Chan, Saratoga, CA (US)

(21) Appl. No.: 14/502,214

(22) Filed: Sep. 30, 2014

Related U.S. Application Data
(63) Continuation-in-part of application No. 13/461,849, filed on May 2, 2012.

(51) Int. Cl. G06Q 30/06; G06F 17/18

(52) U.S. Cl. CPC G06Q 30/0605; G06F 17/18
USPC 705/26.2

(57) ABSTRACT

The present invention generally relates to dividing ownership of indivisible assets. More specifically, the present invention discloses a system and method for dividing, recording, transferring, and verifying ownership of art, collections of art, artifacts, land marks and architecture, sports franchises, rare or collectible items, and other trophy assets which are otherwise physically indivisible. These assets are often too expensive to be owned by most individuals. Particularly with respect to museums and artwork, the system allows organizations to generate revenue from selling fractions of artwork to a plurality of owners while keeping physical possession and stewardship over the artwork.

### FIELD OF THE INVENTION

The present invention generally relates to shared ownership of personal property. Specifically, this invention relates to a system and method for dividing, recording, transferring, and verifying ownership of art, collections of art, artifacts, land marks and architecture, sports franchises, rare or collectible items, and other trophy assets which are otherwise physically indivisible.

### CROSS-REFERENCE TO RELATED APPLICATION

The present application claims priority from non-provisional application Ser. No. 13/461,849 filed on May 2, 2012 and entitled System and Method for Providing Bidding and Execution of Fractional Ownership Assets, the content of which is hereby incorporated by reference into this application.

### BACKGROUND OF THE INVENTION

There exists a class of assets that individual investors and collectors simply are unable to own or invest in simply because the assets are physically indivisible and/or too expensive for most individuals to be able to meet the minimum price of entry into the market. When a Picasso costs a million dollars, the Picasso market is a market of millionaires. These cultural assets include but are not limited to fine art, historically or culturally important real estate (e.g., the Empire State Building, national monuments, parks, and forests), sports franchises, and collectibles (e.g., rare automobiles). Many people feel a deep personal connection to these cultural assets and a sense of responsibility to value and preserve them for future generations, but are unable to do so. The result is that private ownership tends to promote private enjoyment.

In addition to the obvious problem that many people who want to take some ownership in these cultural assets are unable to do so, this may also have the effect of distorting the price of cultural assets. The value that society in general places on cultural assets may not be accurately reflected in the price because of the limited number of players in the market. It may be that the sum of what many individuals are each willing to pay for a small fraction of ownership in an asset is more than what a single person is willing (or able) to pay for the whole.

Finally, Museums, for example, face an ongoing need for funds used to preserve and display works of art. The methods of raising money are typically limited to donations, entrance fees, proceeds from renting out their private collections, and income from hosting events. However, there is potentially a large amount of illiquid capital represented in the cultural assets of the museum's private collection. Selling an artwork to a single buyer usually implies surrendering the artwork itself to the new owner as well, meaning this is once-only source of income. The ability to draw liquid resources from this pool of assets is limited at best.

Museums often serve a public good by owning, and displaying to the public, fine pieces of art. These pieces of art displayed in the public museums are extremely valuable; however, the museums are not in the business of selling pieces to private collectors as doing so would interfere with the primary goal of curating, preserving and displaying valuable pieces of art. Unfortunately, public museums are not immune to business dynamics; they have their own operating expenses and are under constant pressure to be revenue neutral or produce a minimal operating income in order to cover future expenses. Consequently, public museums occasionally have to sell some of their art inventory to remain financially viable. The invention described herein would allow public museums to monetize their assets while retaining possession of them. For example, the Mona Lisa is estimated to be worth $780 million. The Louvre, where the Mona Lisa currently resides, would never consider selling this singular piece of art. However, under this invention, the Louvre would be able to sell 780 shares of the Mona Lisa at $1 million per share, with the understanding that the Mona Lisa would stay at the Louvre in perpetuity and the current investors would have an “exit” at a set interval (e.g., 5 years) where they could elect to sell their shares at a minimum price.

Therefore, there is a need in the art for a system and method which allows the ownership in otherwise indivisible items to be reliably divided and transferred, allowing for multiple different individual investors to collectively own cultural assets. These and other features and advantages of the present invention will be explained and will become obvious to one skilled in the art through the summary of the invention that follows.

### SUMMARY OF THE INVENTION

Accordingly, it is an object of the present invention to provide a system and method for dividing ownership of physical assets, keeping records or ownership, efficiently transferring ownership between investors, and verifying ownership to prevent double-selling and other fraud.

According to an embodiment of the present invention, a system for representing fractional ownership of tangible assets comprises: a processor, a memory, and a title module, wherein the processor, the memory, and the title module are communicatively connected and configured to: receive identifying information of a single tangible asset; receive identifying information of a first owner of the single tangible asset; and create a data record comprising an asset identifier, one or more owner identifiers, and one or more fractions of ownership.

According to an embodiment of the present invention, the system is further configured to: receive identifying information of an additional owner; and create an additional data record comprising an additional owner identifier and an additional fraction of ownership.

According to an embodiment of the present invention, the data record is a master title and further comprises: a master ID; and one or more subordinate IDs, each subordinate ID being a reference to a subordinate title; and wherein the additional data record is a subordinate title and further comprises a subordinate ID.

According to an embodiment of the present invention, the data record is a fractional title and further comprises a fractional ID; and wherein the additional data record is a fractional title and further comprises: a fractional ID; and an additional asset identifier; and wherein the asset identifier of the data record and the additional asset identifier of the additional data record are the same.

According to an embodiment of the present invention, the system is further configured to: receive information corresponding to a buyer; receive confirmation of a payment made to an owner; and update system data representing ownership with a new fraction of ownership for one or more owners.

According to an embodiment of the present invention, the system further comprises a ranking module configured to: receive a value associated with a tangible asset with known value; perform a statistical analysis to determine the portion of value attributable to various elements of a description of the tangible asset; and generate a rank for another tangible asset with unknown value based at least in part on elements of the description in common with the tangible asset with known value.

According to an embodiment of the present invention, the system further comprises an identification module configured to: prevent double registration of a tangible asset; and assign a unique identifier to the tangible asset.

According to an embodiment of the present invention, the system further comprises an ownership verification module configured to check publicly available records to verify the ownership of the tangible asset.

According to an embodiment of the present invention, the system further comprises an identity verification module configured to verify the identity of an owner of the tangible asset;

According to an embodiment of the present invention, the system further comprises: a communication means, and a camera; wherein the processor, the memory, the title module, the communication means, and the camera are communicatively connected and configured to: receive a live image of the tangible asset and transmit the live image to a display element of an owner of a fraction of the tangible asset.

According to an embodiment of the present invention, a method of recording and tracking fractional ownership of tangible assets comprises the steps of: receiving identifying information of a single tangible asset; receiving identifying information of a first owner of the single tangible asset; and creating a data record comprising an asset identifier, one or more owner identifiers, and one or more fractions of ownership;

According to an embodiment of the present invention, the method further comprises the steps of: receiving identifying information of an additional owner; and creating an additional data record comprising an additional owner identifier and an additional fraction of ownership.

According to an embodiment of the present invention, the method further comprises the steps of: assigning a master ID to the data record; assigning a subordinate ID to the additional data record; and referring, in the data record, to the subordinate ID.

According to an embodiment of the present invention, the method further comprises the steps of: assigning a fractional ID to the data record; assigning a fractional ID to the additional data record; and adding the asset identifier of the data record to the additional data record;

According to an embodiment of the present invention, the method further comprises the steps of: receiving information corresponding to a buyer; receiving confirmation of a payment made to an owner; and updating system data representing ownership with a new fraction of ownership for one or more owners.

According to an embodiment of the present invention, the method further comprises the steps of: receiving a value associated with a tangible asset with known value; performing a statistical analysis to determine the portion of value attributable to various elements of a description of the tangible asset; and generating a rank for another tangible asset with unknown value based at least in part on elements of the description in common with the tangible asset with known value.

According to an embodiment of the present invention, the method further comprises the steps of: preventing double registration of a tangible asset; and assigning a unique identifier to the tangible asset.

According to an embodiment of the present invention, the method further comprises the step of checking publicly available records to verify the ownership of the tangible asset.

According to an embodiment of the present invention, the method further comprises the step of verifying the identity of an owner of the tangible asset.

According to an embodiment of the present invention, the method further comprises the steps of: receiving from a camera a live image of the tangible asset; and transmitting the live image to a display element of an owner of a fraction of the tangible asset.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 shows a block diagram of the Fractional System with various hardware components and functional modules according to an embodiment of the present invention.

FIG. 2 is a flow chart depicting various steps of the Ranking Module according to an embodiment of the present invention.

FIG. 3 is a flow chart of the process of submitting an artwork for registration according to an embodiment of the present invention.

FIG. 4 is a flow chart of the process for verifying ownership of an artwork according to an embodiment of the present invention.

FIG. 5 is a graphical representation of the artwork and owner information included in a Master Title according to one embodiment of the present invention.

FIG. 6 is a graphical representation of the owner information included in a Subordinate Title according to an embodiment of the present invention.

FIG. 7 is a graphical representation of the relationship between the Master Title and Subordinate Titles according to an embodiment of the present invention

FIG. 8 is a graphical representation of the artwork and owner information included in a Fractional Title according to an embodiment of the present invention.

FIG. 9 is a graphical representation of the artwork and owner information included in a Multi-owner Title according to an embodiment of the present invention.

FIG. 10 is a graphical representation of the data structure in computer memory corresponding to a Master Title, a Subordinate Title, a Fractional Title and a Multi-Owner Title according to various embodiments of the present invention.

FIG. 11 is a flow chart of the process for transferring a fraction of ownership according to an embodiment of the present invention.

### DETAILED SPECIFICATION

The present invention generally relates to shared ownership of personal property. Specifically, this invention relates to a system and method for dividing, recording, transferring, and verifying ownership of fine art, collections of art, historical artifacts, historic land marks and architecture, sports franchises, rare or collectible items, and other trophy assets which are otherwise physically indivisible.

The present invention is intended to be used with any physical asset which is indivisible and/or too expensive to be obtainable by most people on their own. However, in order to clearly illustrate the concepts of the invention, examples will refer to a piece of artwork. One or ordinary skill in the art will appreciate that a piece of artwork is merely representative of a larger class of assets that have traditionally been difficult to divide among multiple owners, and the example of artwork should not be seen as limiting the scope of the present invention.

In general, there are several security concerns that need to be monitored by the Fractional System in order to successfully implement a fractional ownership system. These include: preventing the double registration of artworks, preventing the double sale of an artwork, preventing registration of an artwork to someone who is not the real owner, preventing a registrant from assuming the identity of another, and preventing registration of an artwork that doesn't actually exist. It is also important to prevent the registration of forged artworks, but that is not orthogonal to the other concerns and tends to overlap across several of them. In other words, the problem of forged artworks is mostly solved by verifying ownership, identity, and uniqueness related to an artwork.

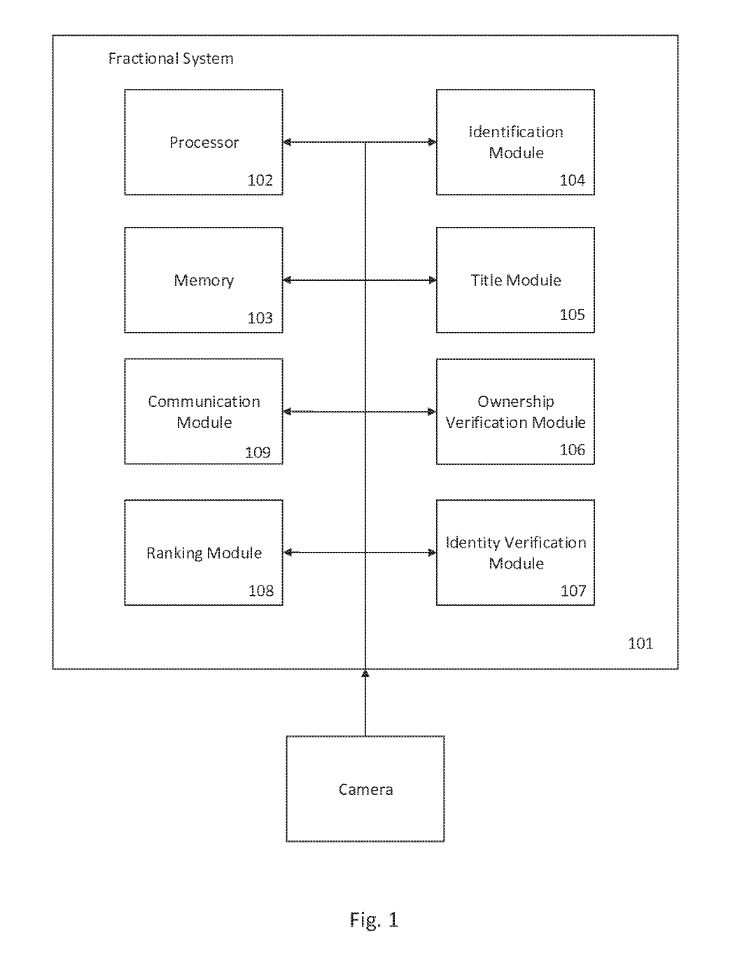

FIG. 1 shows a block diagram of an exemplary embodiment of the Fractional System 101, including functional modules for maintaining the security and functionality of the system. The functional system includes a processor 102 and a memory 103 which are communicatively connected to each other and to various functional blocks, including an Identification Module 104, a Title Module 105, an Ownership Verification Module 106, an Identity Verification Module 107, and a Ranking Module 108. A Communication Module 109 may also be included for communication with third party auxiliary service providers and/or with users of the Fractional System 101. These Modules may be implemented in hardware, software, or a combination of both.

According to an embodiment of the present invention, The Fractional System 101 also includes a camera 110. This camera may connect to the Fraction System and a live video feed from the camera may be sent to fractional owners using the Communication Module 109. This allows fractional owners to have 24-hour visual access to the artworks they own. The live video feed is accessible through a web site, desktop application, or mobile application and can be accessed on personal devices and/or displayed on a display element on a personal device or in the home.

The Identification Module 104 is used in a variety of security functions of the Fractional System, including preventing double registration of an artwork, preventing double sale of an artwork, and preventing registration of an artwork that doesn't actually exist. The Identification module 104 does this in several ways. First, when an artwork is registered, the Identification Module 104 compares the submitted description to descriptions already in the database. For example, someone might attempt to register Cézanne's Still Life with a Curtain. If the Identification Module 104 finds another artwork from an artist called Cezanne (missing the accent on the e) and titled still life with curtain (missing “a”), then there is a conflict and registration is suspended until the conflict is resolved. If the conflict is not resolved within a reasonable amount of time, the registration may be permanently cancelled. The Identification Module 104 uses flexible search criteria to allow for variations in spelling, artworks with multiple titles, conflicting artist attributions, and varying descriptions. Images of the artwork can also be used to determine if the artwork is unique in the system. There are a variety of data that can be compared in order to determine if an artwork has already been registered in the system. One of ordinary skill in the art would recognize any data associated with an artwork, including but not limited to, insurance ID number, medium, artist, title, creation date, location, description, value, and/or digital image may be used to identify the artwork without departing from the spirit and scope of the present invention.

The Identification Module 104 can also help prevent double sales of the artwork outside the Fractional System 101 by creating an Asset ID to uniquely identify the artwork. This Asset ID can be reproduced on a label or tag through a variety of means, including but not limited to, text, magnetic strip, bar code, QR code, and/or RFID tag. The label or tag is then affixed to the artwork in a noticeable manner to prompt potential buyers to check the ownership status of the artwork by accessing the fractional system. This is usually done through an interactive web site or mobile application.

The Identification Module 104 could also be configured to help prevent registration of artworks that don't exist by requiring an image of the artwork to be uploaded. Although there is a certain amount of identification based on this image that can be done with software, a certain amount of human interaction may be required. To avoid the requirement to employ art experts, the Identification Module 104 may be configured to get approval or verification of artworks from peers or other users of the Fractional System 101. This can be done by presenting users with proposed registrations, including the image and description. Users should be able to spot weak attempts to fool the system, and may be the best source of information on the latest artists and their works. Once a certain number of approvals are received the artwork can be assumed to be real. Multiple images may also be used for artworks that cannot be fully captured in two dimensions.

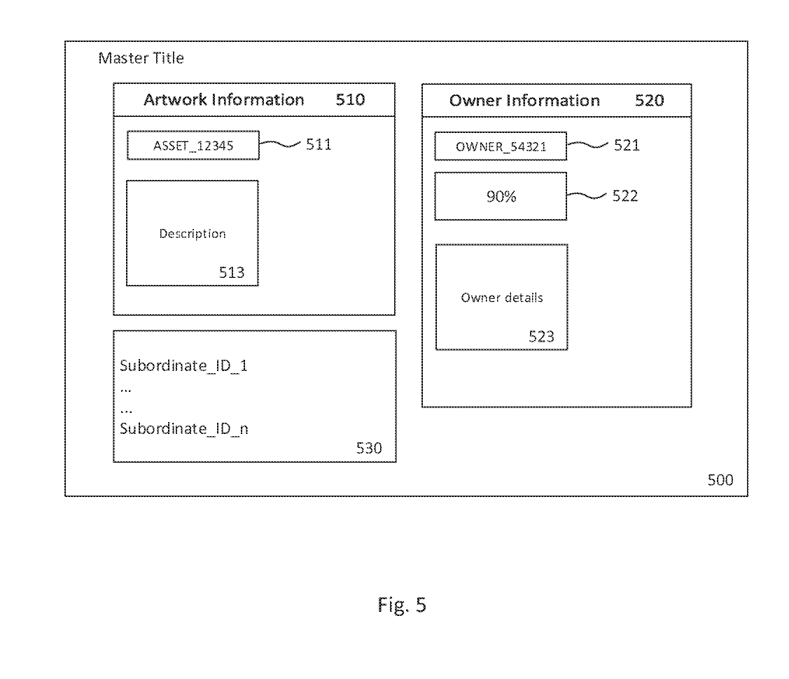

The Title Module 105 manages creation and update of Titles described in FIGS. 5-9. It naturally prevents double sale of artworks within the system by not allowing more than 100% of an artwork to be sold and keeping accurate records of ownership. There are two approaches to keeping track of ownership: the first is to maintain the current ownership status in the various Titles, the second is to keep a record of all transactions and determine ownership through transactional history. Each method has its benefits, but by using both, the Title Module can use each to verify the accuracy of the other. This would help provide rapid notification and backup in case of data corruption or hacking.

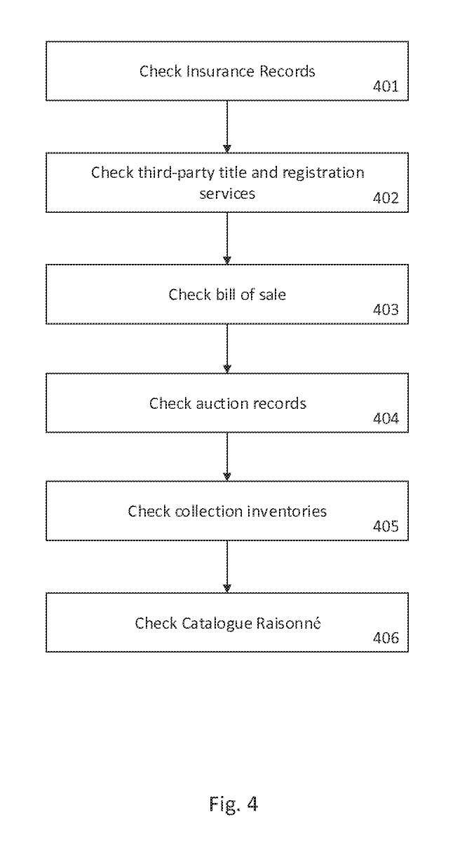

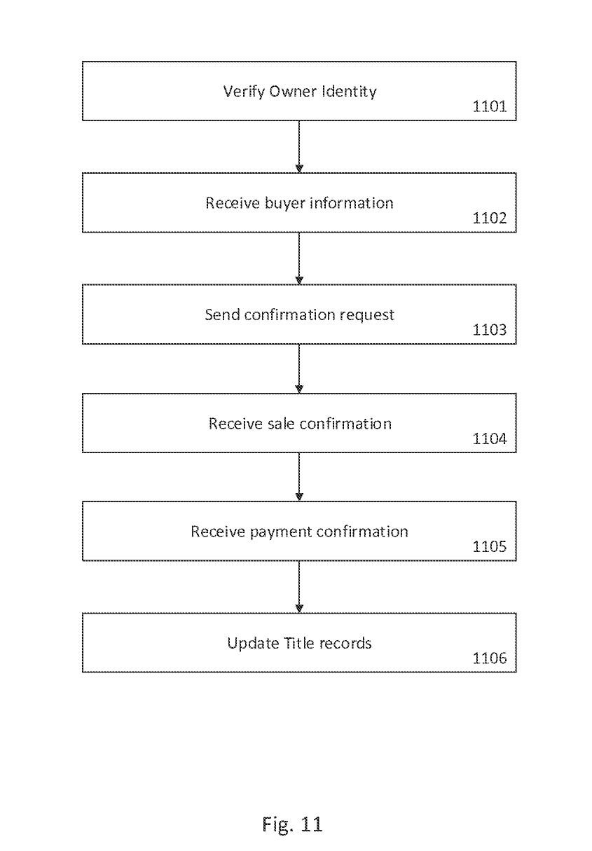

The Ownership Verification Module 106 and Identity Verification Module 107 handle verification of ownership and identity verification described in FIG. 4 and FIG. 11 respectively.

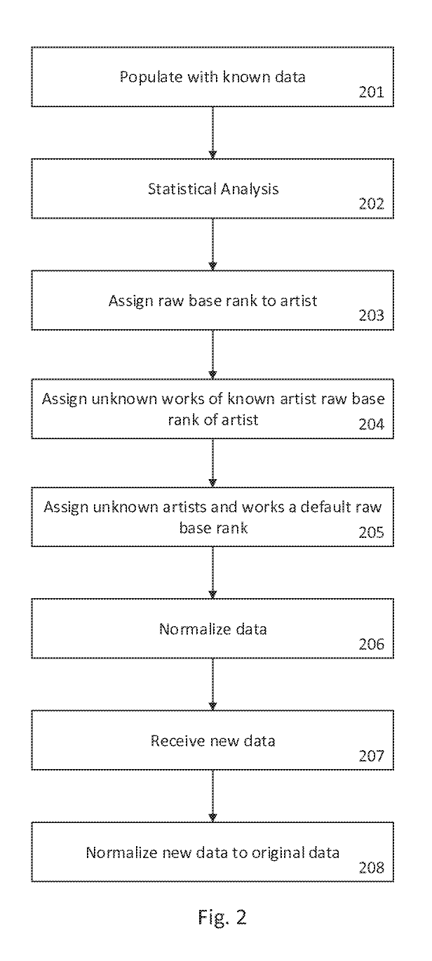

The Ranking Module 108 is responsible for determining the fame, prestige, and/or value of a particular artwork. The rank of an artwork is primarily used to determine the appropriate level of ownership verification required for registration and/or identity verification required before a sale or transfer can be made. Details of the Ranking Module are further explained in relation to FIG. 2.

Referring to FIG. 2, the Ranking Module 108 is initially populated with data from known artist and artworks at step 201. This information can come from auction records, insurance records, museum and private collector inventories, and/or catalogues raisonné. The primary ranking mechanism is monetary value, but it is conceivable that some artworks will not have a readily available monetary value because they have never been sold or have not recently been sold. A value can be assigned to many of these works from insurance records. The Ranking Module then performs a statistical analysis by artist at step 202. This analysis determines the amount of the value of each artwork that is attributable to the artist. At step 203, the Ranking Module 108 assigns each artist a raw base rank that is at least partially determined by the statistical analysis of step 202. In step 204, unknown works from known artists are given a raw rank at least as great as the raw base rank assigned to the artist and unknown artists (or artists with insufficient data for a statistical analysis) are assigned a default raw base rank in step 205. These raw rankings are then normalized across the entire database in step 206 to produce a normalized rank. Normalization helps to keep the rank within a manageable range even as sales prices continue to rise and values continue to appreciate. When new data is received in step 207, the Ranking Module 108 performs a new analysis on the artist for which new data was received in step 208 and the new raw rank is normalized to conform with the rest of the database in step 209.

The new data in step 207 may be an update of one of the previously used data sources or it may come from within the system when a transaction is completed. The monetary value of the transaction can affect the rank of the artwork that was fractionally sold. This data is particularly useful when it corresponds to an artist that was previously given a default value for the base rank. When this kind of artwork is fractionally sold within the Fractional System, the transaction provides the first data point for determining the rank of the artwork in relation to the rest of the artworks known to the Ranking Module.

The Ranking Module 108 may also divide the rankings into tiers where each tier is associated with a particular level of required verification of ownership and/or identity. At the low end, low ranked artists and artworks may require only minimal verification. In the middle, certain artworks may require at least some documented evidence of a transaction that gave ownership. At the high end, multiple types of verification, such as insurance records, and auction records may be required. There is no set number of tiers required and one of ordinary skill in the art would recognize that any number of tiers may be defined, or none at all. Having no tiers would produce virtually continuously variable verification requirements.

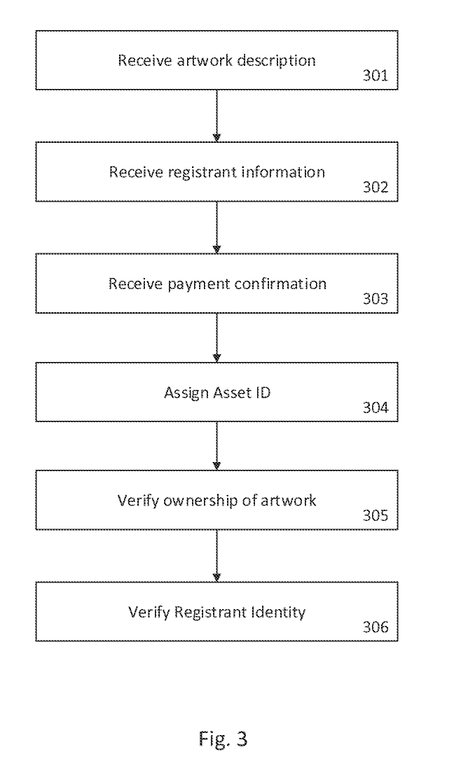

According to an embodiment of the present invention, in order for an owner of an artwork to sell one or more fractions of the artwork, it must be registered with the Fractional System. FIG. 3 shows a flowchart of the process of registering an artwork. At step 301, the Fractional System receives the artwork description. According to an embodiment of the present invention, the description may include, but is not limited to, the artist, title, year of creation, a text description of the artwork, style, size, medium, location, insurance policy number and company, and/or an electronic image of the artwork. One of ordinary skill in the art would recognize that there is a high degree of flexibility in what information is used to identify or describe an artwork, and it is contemplated that a description may include more or fewer than these elements without departing from the spirit and scope of the present invention.

At step 302 the Fractional System receives information about the Registrant who is presumably the owner of the artwork. The Registrant may be identified by name, username, user ID, a pseudonym, corporation, organization, or by contact information. One of ordinary skill in the art would recognize that there are a variety of ways to identify a Registrant without departing from the spirit and scope of the invention. The fractional ownership system may optionally also receive a digital image of the artwork. This can be helpful in identifying and/or verifying the description of the artwork and/or its ownership.

At step 303, the Fractional System then confirms payment of a registration fee. Although payment is not necessary to implement the present invention, it has the benefit of helping to verify ownership of an artwork and discouraging fraud because a Registrant who doesn't actually own a piece of artwork is less likely to be willing to pay money to register it on the Fractional System. The mere act of registering an artwork on the Fractional System does not operate as proof of ownership. This fraud prevention effect is somewhat diminished with high value artworks, but ownership of high value artworks also tends to be easier to verify by other means, which will be discussed below. Obviously charging a registration fee is not a foolproof guarantee against fraud, but it is a cost effective way to prevent mass spamming that plagues free sites like Craigslist and internet forums. Payment can be processed either directly by the Fractional System, or referred to a third party payment processor. One of ordinary skill in the art would recognize that there are a variety of ways that payment can be handled without departing from the spirit and scope of the present invention.

At step 304, the Fractional System assigns an Asset ID to the artwork. The Asset ID is a unique identifier that is used by the system to track an artwork and associate information, such as fractional ownership with it.

At step 305, the Fractional System proceeds to verify ownership. Ownership verification is not a binary determination with regard to an artwork, but there are degrees of verification that can be completed. Various exemplary steps for completing a strong verification of artwork ownership are described in greater detail in FIG. 4. Although ownership verification is not necessary for the practice of the present invention, when this information is provided to potential buyers, it provides some assurance that the seller does indeed own what he claims to own. This helps to make the system more practical and usable in the real world.

At step 306, in order to prevent fraud, it may also be desirable for the Fractional System to verify the identity of the Registrant. Verifying that a certain name appears on insurance, title, inventory, auction, or other records does not necessarily mean that the Registrant is that same person. Verifying the identity of the Registrant can help prevent the type of fraud where the Registrant falsely pretends to be someone he isn't, while verifying ownership helps prevent the type of fraud where a Registrant falsely pretends to own a painting he doesn't own. Optionally, verifying Registrant identity can be deferred until the registrant actually attempts to sell some fraction of the artwork. Verification of Registrant identity can be done by standard methods, including but not limited to, credit checks, public records, personal questions, social security number, biometrics, government ID number, or any other way of positively identifying a person. One of ordinary skill in the art would recognize that a variety of identification systems and methods may be used to verify the identity of the registrant without departing from the spirit and scope of the present invention.

The Fractional System may require verification at a predetermined level before registration of an artwork is complete. This level may be anywhere from minimal, such as a mere assertion of ownership, to robust, such as checking public auction records or an art title company. In certain situations, it may be desirable to send one or more art experts to physically inspect the artwork and verify its authenticity. The predetermined level required may change depending on the value or fame of the artwork. For example, the Mona Lisa would require significant verification before registration is completed, but a 4-year-old's crayon scribbles might be verified by a mere assertion of ownership. The predetermined level required may be continuously variable. For example, the registration fee might be tied to a percentage of the value of the artwork. Once the predetermined level of verification is reached, the Fractional System can proceed to step 306 and create a Title. The details of the various embodiments of a Title are described in greater detail in reference to FIGS. 5-9.

FIG. 4 shows a flow chart for the process of verifying ownership. At step 401 the Fractional System checks insurance policy records to verify the name of the party which has insured the artwork that is being registered. For additional security, the Registrant may be required to name the insurance company which provides insurance on the artwork. For privacy reasons, this verification may be done by sending a query to the insurance company asking if the Registrant is listed as the holder of an insurance policy on the named artwork. The response would be either a confirmation or denial without disclosing the name of the actual policy holder. The exact protocol for confirming insurance records is unimportant and one of ordinary skill in the art would recognize that the present invention may be implemented using any method of verifying insurance records. Clearly, not all artworks are valuable enough to be insured, so this method of ownership confirmation is not always appropriate.

At step 402, the Fractional System checks with one or more third party art title and registration services. Although the Fractional System may itself act as an artwork title and registration service, it is also possible to cooperate with existing art title companies to verify ownership of an artwork. The exact protocol for verifying ownership through an art title company is unimportant and one of ordinary skill in the art would recognize that the present invention may be implemented using any method of verifying ownership through a third party art title company.

At step 403 the Fractional System may check a bill of sale. This bill of sale could be submitted by the Registrant or retrieved from public records. The exact method for verifying ownership through a bill of sale is unimportant and one of ordinary skill in the art would recognize that the present invention may be implemented using any method of verifying ownership through a bill of sale.

At step 404 the Fractional System checks auction records for a transfer of ownership to the Registrant. Auction records may not contain a record of the most recent transaction, but they can at least be used to verify that the artwork was at one time sold to the Registrant and the value of that transaction. This value can then also be used to determine the appropriate registration fee or level of ownership verification required before registration is considered complete. There is no particular set of steps required by the present invention in order to verify ownership through auction records and one of ordinary skill in the art would recognize that any method of verifying ownership through auction records could be used without departing from the spirit and scope of the present invention.

At step 405, the Fractional System checks art collection inventories for a record of ownership. Many private collectors and museums keep records of which artworks they own. These records are sometimes made public and can be a good source of information about who currently owns or once owned an artwork. One of ordinary skill in the art would recognize that any kind of inventory or ownership list could be used to improve ownership verification of an artwork without departing from the spirit and scope of the present invention.

At step 406, the Fractional System checks catalogues raisonné for records of ownership. Catalogues raisonné are records kept or compiled either by artists themselves or other organizations. These records contain descriptions of artworks and sometimes records of who purchased them. However, catalogues raisonné do not always have records after the first sale so they do not always produce a high level of certainty of the present owner. Regardless catalogues raisonné can be a useful tool in identifying and verifying ownership of artworks.

Ownership verification, by whatever means, may be done automatically by computer communications or manually by having a human being track down paper documents and enter data into the Fractional System. Each of the steps may be performed in combination with the others or in isolation. Not all verification methods need to be performed and there is no particular order that they should be performed in. However, as more verification methods are used, the verification level becomes stronger. Thus, for highly prized artworks, the Fractional System may require multiple methods of verification before registration is considered complete. One of ordinary skill in the art would recognize that ownership verification may be completed using more or fewer than the methods described above or they may all be replaced by a more robust, cost-effective, and/or efficient method of verification, if and when it becomes available, without departing from the spirit and scope of the present invention.

Various embodiments of creating a Title used for keeping track of fractional ownership of the artwork will now be discussed with reference to FIGS. 5-9. The term Title refers to a document or record used to provide proof of ownership or the physical or electronic document or data structure that is used to manage and track ownership of an artwork without necessarily acting as proof of ownership. In other words, the term Title, as used in the specification covers generally the bundle of rights in a piece of property, the legal document or the physical or electronic data structure used to organize, and manage fractional ownership of an artwork.

According to an embodiment of the present invention, FIG. 5 shows a graphical representation of the Master Title 500. The information contained in a title may be broken into two categories: the artwork information 510 and the owner information 520. The artwork information includes an Asset ID 511, which is a unique identifier for the artwork in the Fractional System. It is intended that this Asset ID 511 be made publicly available so that anyone can check the registration status and ownership breakdown of an artwork. The Master Title 500 also includes at least one Owner ID 521, which uniquely identifies the owner of the artwork within the Fractional System. The Owner ID 521 need not be made publicly available, but one or more Public Owner IDs may be used to simplify finding artwork ownership information associated with a particular person. The Master Title 500 also includes a Fractional Interest 522 which is associated with the Owner ID 521 and represents the fraction of the asset identified by the Asset ID 511 that is owned by the owner identified by the Owner ID 521.

The Master Title may also include a description 513, which comprises any information useful for describing the artwork, including but not limited to, an insurance ID number, medium, the artist, title of the work, creation date, location, a text description, value, and/or digital image of the artwork. One of ordinary skill in the art would recognize that different asset types may require different information in the description, and information may be included or excluded without departing from the spirit and scope of the present invention. Alternatively, the description could be stored in a separate logical or physical location and associated with the AssetID 511 so the information could be retrieved as needed.

The Master Title 500 may also include owner details 523, which comprises any information useful for describing or identifying the owner, including but not limited to, name, address, contact information, percentage of the artwork owned, price paid, ownership verification level, and/or identity verification level. By default at the time of registration, the owner may be automatically assigned a 100% fraction of the artwork. One of ordinary skill in the art would recognize that a variety of different information may be included in the owner details 523 of the Master Title 500 without departing from the spirit and scope of the present invention. Alternatively, owner details 523 could be stored in a separate logical or physical location and associated with the Owner ID 521 for retrieval as needed.

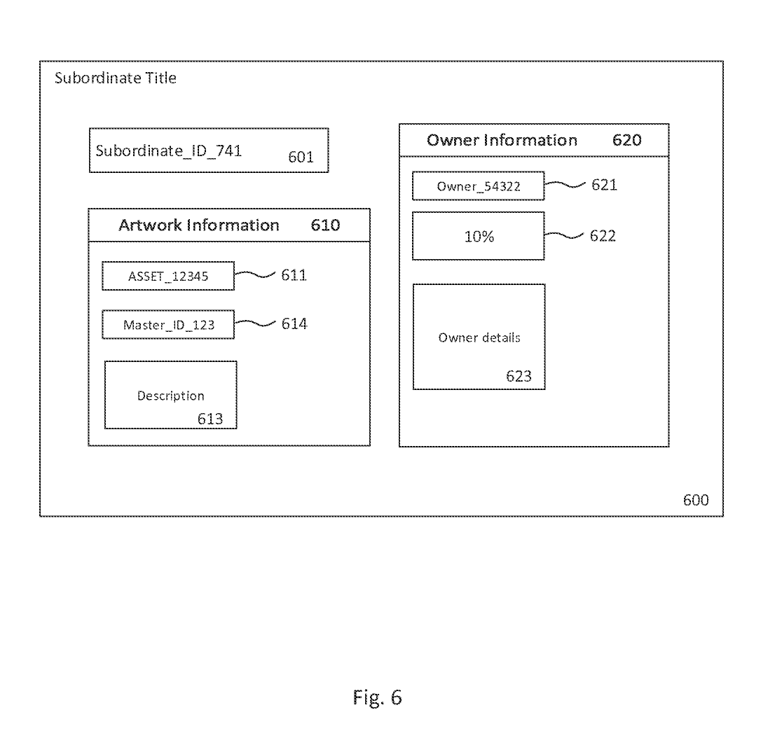

If the artwork owner has sold any fraction of the artwork, the Master Title will also include references to one or more Subordinate Titles 530. The structure of a Subordinate Title is described in more detail in FIG. 6.

Referring to FIG. 6, a Subordinate Title 600 has a Subordinate ID 601 which uniquely identifies the Subordinate Title 600. The Master Title 500 and Subordinate Title 600 are linked to each other by at least one of: (a) The Master Title 500 including a reference to the Subordinate ID 601; (b) the Subordinate Title 600 including a reference to a Master Title ID 614; and (c) both the Master Title 500 and Subordinate Title 600 including a reference to the Asset ID 511. One of ordinary skill in the art would recognize that linking the Master Title 500 to the Subordinate Title 600 could be done in a variety of ways without departing from the spirit and scope of the present invention.

The Subordinate Title 600 also contains owner information 620 and optionally contains artwork information 610. Artwork Information 610 may comprise an Asset ID 611 and/or a Master ID which refers to the Master Title 500 to which this Subordinate Title 600 is linked. an owner information 520 includes an Owner ID 621, which uniquely identifies the owner of the artwork within the Fractional System and a Fractional Interest 622 for that Owner ID 621. The Subordinate Title 600 may also include owner details 623, which comprise any information useful for describing or identifying the owner, including but not limited to, name, address, contact information, percentage of the artwork owned, price paid, ownership verification level, and/or identity verification level. Alternatively, owner details 623 could be stored in a separate logical or physical location and associated with the Owner ID 621 for retrieval as needed.

The Subordinate Title 600 may also include a description 613, which comprises any information useful for describing the artwork, including but not limited to, an insurance ID number, medium, the artist, title of the work, creation date, location, a text description, value, and/or digital image of the artwork. Alternatively the Subordinate Title 600 could refer to the Master Title 500 or the Asset ID 611 in order to retrieve information about the artwork as needed. One of ordinary skill in the art would recognize there are a variety ways to store or reference the information associated with a Subordinate Title 600.

When using a Master Title 500 and Subordinate Title 600, transferring a fractional interest would require updating the Fractional Interest 522 of the Master Title 500 and updating or creating a new Subordinate Title 600.

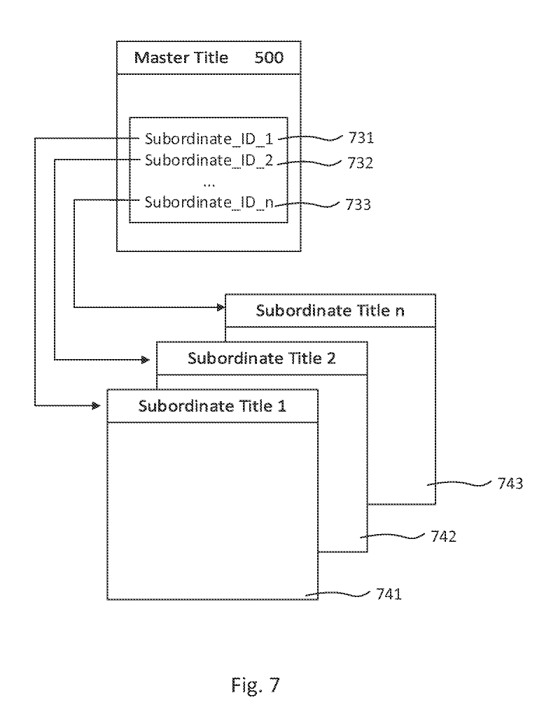

FIG. 7 shows a graphical representation of the relationship between the Master Title 500 and one or more Subordinate Titles 600. Each Subordinate Title Reference 731, 732, and 733 points to one Subordinate Title 741, 742, and 743 respectively.

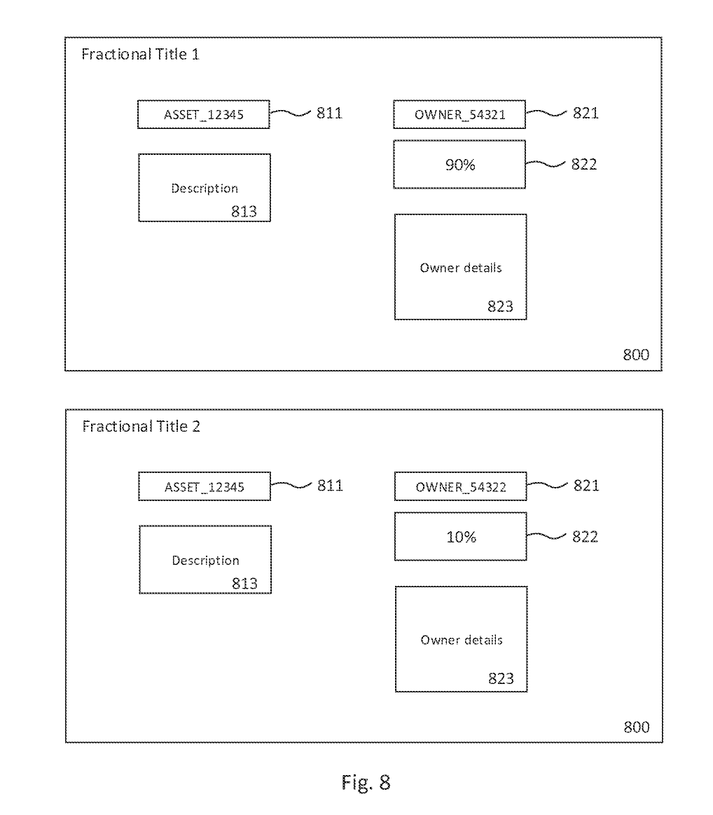

In an alternate embodiment of the present invention, a Fractional Title is depicted in FIG. 8. A Fractional Title 800 comprises an Asset ID 811, an Owner ID 821, and a Fractional Interest 822. Each fractional owner is associated with at least one Fractional Title 800 and the whole ownership of an artwork is represented by all of the Fractional Titles that include the Asset ID 811 of the artwork. The Fractional Title may optionally include a description of the artwork and owner information, or this information may be stored in a separate logical or physical location associated with the Asset ID 811 or Owner ID 821 and retrieved as needed.

When using Fractional Titles 800 to represent ownership of an artwork, transferring a fractional interest would require updating the Fractional Interest 821 of the seller and updating or creating a Fractional Title 800 for the buyer.

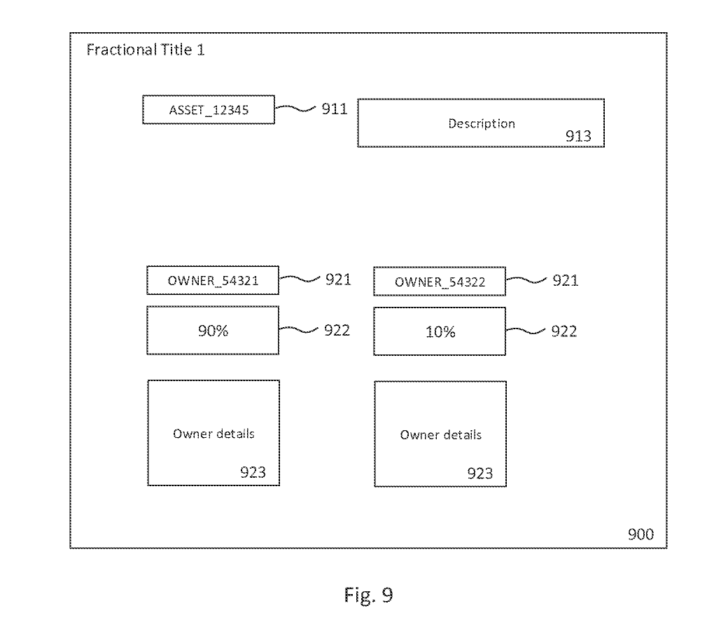

FIG. 9 is a graphical diagram of a Multi-Owner Title 900 of another alternate embodiment of the present invention. A Multi-Owner Title 900 comprises an Asset ID 911, and an Owner ID 921 and Fractional Interest 922 for each fractional owner of the artwork. The Multi-Owner Title 900 may also include a description 913 of the artwork and owner details 923. Alternatively, the description 913 and owner details 923 could be stored in a separate logical or physical location and retrieved as needed.

When using a Multi-Owner Title to represent ownership of an artwork, transferring a fractional interest would require updating the owner information 920, including the Fractional Interest 922 associated with two or more Owner IDs 921. Transfer of a fractional interest is described in greater detail with reference to FIG. 11.

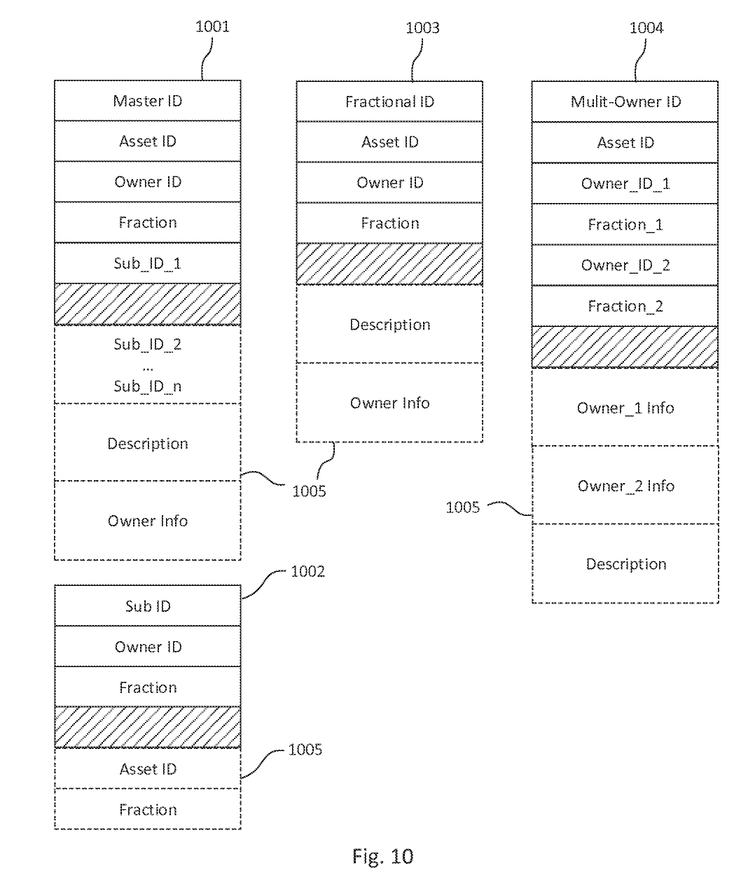

The respective data structures within computer memory for each type of Title are depicted in FIG. 10. Each line represents an arbitrarily sized chunk of memory and dashed lines represent optional data. The Master Title 1001 and Subordinate Title 1002 are logically separate data structures. The Fractional Title 1003 is simple and lightweight and provides the same structure for the title of the owner who originally registered the artwork in the Fractional System and other fractional owners. The Multi-Owner Title 1004 keeps critical ownership data in a single logical structure. In all cases, additional details 1005 can be stored in the title data structure or referenced to a separate logical or physical location.

FIG. 11 shows a flow chart of the steps for transferring a fraction of ownership from a seller to a buyer. At step 1101 the Fractional System verifies the identity of the Owner. This step may be done at the time of registration or it may be postponed until a transfer is attempted. Verifying the identity of the owner prevents fraud where someone who does not have possession of an artwork assumes the identity of the person who is verified or known to be in possession of the artwork. This is a kind of fraud risk that is unique to the fractional ownership system because a sale does not necessarily require transfer of the artwork from the seller to the buyer, so one cannot rely on possession as a signal of ownership. Identity verification can be accomplished through any identity verification method, including but not limited to Private/Public Key Infrastructure, credit checks, background checks, public records, biometrics, government issued identification numbers, credit cards, or bank transfers. In the case of high profile artworks, it is important that the actual identity of the registered owner be verified to match the actual owner of the physical artwork. Therefore, merely checking a username and password, without other identity verification steps, would be insufficient verification for a high profile artwork as it only verifies that the seller is the same as the person who registered the artwork with the system.

At step 1102, the Fractional System receives the buyer information. This information could be submitted either by the buyer or the seller. The system then sends a confirmation request at step 1103. If the seller is entering information, it should be confirmed with the buyer to ensure that the information was entered correctly. If information was entered by the buyer, it should be confirmed with the seller to ensure the transaction is authorized. The simplest way to do this is by email, but other methods such as phone call, fax, post, or courier could also be used. At step 1104, the Fractional System receives confirmation of the transaction information. This verifies that the contact information (e.g. email) and details of the transaction (e.g. name, price, etc.) are correct. In some cases, confirmation of the transaction may be done automatically. For example, if the seller uses an online auction platform to sell a percentage of ownership, the details of the transaction will likely already be available and a confirmation outside of the auction system would be unnecessary. The Fractional System then receives confirmation of payment at step 1105. If payment in processed by the Fractional System, confirming payment can be done internally and automatically. Payment can also be processed through a third party such as an escrow service, Paypal, or merely waiting for the seller to confirm that payment was received and release the transaction. There are security benefits to processing the payment internally as this allows the Fractional System to be a mediator in dispute resolutions. After payment is confirmed, the Fractional System updates the Title at step 1106. Depending on the Title scheme used, this may require creation of a Subordinate Title or Fractional Title, and/or updating a Master Title, Subordinate Title, Fractional Title, or Multi-Owner Title.

According to an embodiment of the present invention, The Fractional System may create a structured timeframe for entering and exiting an investment in an artwork. For example, the system may have a minimum investment period, such as one year, and investors cannot sell their share within one year of the initial investment. Each year an exit window is defined at a particular time. Investors may choose to exit the investment, or remain until the next exit window.

The advantage of the fixed exit window can be illustrated with the case of a museum or municipality. Suppose a museum needs money but doesn't want to give up any pieces of its collection. The museum may have in its possession Rembrandt's Aristotle Contemplating the Bust of Homerwith an estimated value of $100 million. Through the Fractional ownership system, the museum may divide the painting into 100 shares of $1 million each and provide a guaranteed rate of return on the investment. At the end of the investment period, the investor may choose to cash out with the guaranteed return, sell the share at auction, or stay invested for another investment period. In the meantime, the museum may use the funds to acquire additional artworks, or preserve, display, and monetize artworks already in its possession.

In general, it is to be understood that even though fractions of an artwork are to be sold, the artwork itself is not necessarily intended to be physically divided. Typically, the owner would either keep the artwork, or place it in the care of a museum or some other responsible party. In the case that the owner keeps the artwork, he may be required to maintain insurance and/or take security measures to prevent theft, damage, or loss. Fractional owners of the artwork may even have visitation rights. The seller may promise to have the artwork placed in a particular museum upon his death or after a period of years. The seller may even allow investors to vote on which museum the artwork is to be placed in at the appropriate time. In the case of a museum, the artwork would be kept with the museum in perpetuity with insurance and security requirements and conditions for transfer in the event that the museum is ever closed. Again the location of transfer could be established by vote of the owners. The present invention places no artificial limits on the terms and conditions that a seller and buyer may agree to in the transfer of a fraction of the artwork.

Although some system of sharing physical possession of the artwork is not excluded or discouraged, it is not necessary that buyers ever receive any kind of physical possession of the artwork they purchased a fraction of Because artwork tends to appreciate in value over time, buyers would have an incentive to buy simply because they can sell their share later at a higher price. Of course, buyers might also purchase fractional ownership in artwork for their own personal satisfaction, dinner party conversation, or simply out of a desire to support preservation of the artwork. The present invention places no artificial requirements on the motive of the buyer of fraction of an artwork.

The ability to sell an artwork while keeping possession of it is of particular value to an institution such as a museum. Selling fractional ownership in artworks presents museums with an opportunity to generate an additional stream of revenue tied to a particular artwork without having to give up possession. In addition, the system of the present invention may be configured to charge fees and/or a percentage of the increase in value on each subsequent transfer of fractional ownership after the original transaction. This means that the museum that fractionally sold the artwork does not, as a result, miss out entirely on future appreciation of the artwork.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

Connection to networks may be required or desirable in order to receive data from any number of sources required for generation of the user interface in accordance with embodiments of the present invention. According to an exemplary embodiment, exchange of information through the network may occur through one or more high speed connections. In some cases, high speed connections may be over-the-air (OTA), passed through networked systems, directly connected to one or more networks or directed through one or more routers. Router(s) are completely optional and other embodiments in accordance with the present invention may or may not utilize one or more routers. One of ordinary skill in the art would appreciate that there are numerous ways to connect to a network for the exchange of information with a mobile computing device or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

Components of the system may connect to each other or a network in numerous ways. For instance, a component may connect to the system: i) through a computing device directly connected to the network, ii) through a computing device connected to a WAN through a routing device, iii) through a computing device connected to a wireless access point or iv) through a computing device via a wireless connection (e.g., CDMA, GMS, 3G, 4G) to a network. One of ordinary skill in the art would appreciate that there are numerous ways for system components to connect to each other and/or a network 201, and embodiments of the present invention are contemplated for use with any method of connection.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, the display element of the system may be, for instance, any type of display that is capable of displaying information to a user. In some embodiments, the display element may also be used as a user interface through which a user both receives information and enters information about a review. In a preferred embodiment, the system is configured to display a review survey and collect feedback through a user interface presented on a display element, such as a screen of a smartphone or tablet PC. Display elements may include, but are not limited to, e-ink screens, heads-up displays (e.g., presented on wearable display elements such as glasses), wearable displays (e.g., watches), smartphone displays, tablet PC displays, or any combination thereof. One of ordinary skill in the art would appreciate that there are numerous display elements that might be utilized with embodiments of the present invention, and embodiments of the present invention are contemplated for use with any display element.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for representing fractional ownership of tangible assets comprising:
a processor,
a memory, and
a title module,
wherein said processor, said memory, and said title module are communicatively connected and configured to:
receive identifying information of a single tangible asset;
receive identifying information of a first owner of said single tangible asset; and
create a data record comprising an asset identifier, one or more owner identifiers, and one or more fractions of ownership.

2. The system of claim 1 further configured to:
receive identifying information of an additional owner; and
create an additional data record comprising an additional owner identifier and an additional fraction of ownership.

3. The system of claim 2 wherein said data record is a master title and further comprises:
a master ID; and
one or more subordinate IDs, each subordinate ID being a reference to a subordinate title; and
wherein said additional data record is a subordinate title and further comprises a subordinate ID.

4. The system of claim 2 wherein said data record is a fractional title and further comprises a fractional ID; and wherein said additional data record is a fractional title and further comprises:
a fractional ID; and
an additional asset identifier; and
wherein the asset identifier of said data record and the additional asset identifier of said additional data record are the same.

5. The system of claim 1 further configured to:
receive information corresponding to a buyer;
receive confirmation of a payment made to an owner; and
update system data representing ownership with a new fraction of ownership for one or more owners.

6. The system of claim 1 further comprising a ranking module configured to:
receive a value associated with a tangible asset with known value;
perform a statistical analysis to determine the portion of value attributable to various elements of a description of said tangible asset; and
generate a rank for another tangible asset with unknown value based at least in part on elements of the description in common with said tangible asset with known value.

7. The system of claim 6 further comprising an identification module configured to:
prevent double registration of a tangible asset; and
assign a unique identifier to said tangible asset.

8. The system of claim 7 further comprising an ownership verification module configured to check publicly available records to verify the ownership of said tangible asset.

9. The system of claim 8 further comprising an identity verification module configured to verify the identity of an owner of said tangible asset;

10. The system of claim 1 further comprising:
a communication means, and
a camera;
wherein said processor, said memory, said title module, said communication means, and said camera are communicatively connected and configured to:
receive a live image of said tangible asset and transmit said live image to a display element of an owner of a fraction of said tangible asset.

11. A method of recording and tracking fractional ownership of tangible assets comprising the steps of:
receiving identifying information of a single tangible asset;
receiving identifying information of a first owner of said single tangible asset; and
creating a data record comprising an asset identifier, one or more owner identifiers, and one or more fractions of ownership;

12. The method of claim 11 further comprising the steps of:
receiving identifying information of an additional owner; and
creating an additional data record comprising an additional owner identifier and an additional fraction of ownership.

13. The method of claim 12 further comprising:
assigning a master ID to said data record;
assigning a subordinate ID to said additional data record; and
referring, in said data record, to said subordinate ID.

14. The method of claim 12 further comprising:
assigning a fractional ID to said data record;
assigning a fractional ID to said additional data record; and
adding said asset identifier of said data record to said additional data record;

15. The method of claim 12 further comprising the steps of:
receiving information corresponding to a buyer;
receiving confirmation of a payment made to an owner; and
updating system data representing ownership with a new fraction of ownership for one or more owners.

16. The method of claim 12 further comprising the steps of:
receiving a value associated with a tangible asset with known value;
performing a statistical analysis to determine the portion of value attributable to various elements of a description of said tangible asset; and
generating a rank for another tangible asset with unknown value based at least in part on elements of the description in common with said tangible asset with known value.

17. The method of claim 16 further comprising the steps of:
preventing double registration of a tangible asset; and
assigning a unique identifier to said tangible asset.

18. The method of claim 17 further comprising the step of checking publicly available records to verify the ownership of said tangible asset.

19. The method of claim 18 further comprising the step of verifying the identity of an owner of said tangible asset.

20. The method of claim 19 further comprising the steps of:
receiving from a camera a live image of said tangible asset; and
transmitting said live image to a display element of an owner of a fraction of said tangible asset.
